(19) United States
(12) Patent Application Publication
(10) Pub. No.: US 2026/0172659 A1
(43) Pub. Date: Jun. 18, 2026

(54) IN-VEHICLE IMAGE CAPTURE DEVICE

(71) Applicant: VALEO COMFORT AND DRIVING ASSISTANCE, Créteil (FR)

(72) Inventor: Tatiana Grulois, Creteil (FR)

(73) Assignee: VALEO COMFORT AND DRIVING ASSISTANCE, Créteil (FR)

(21) Appl. No.: 19/125,173

(22) PCT Filed: Sep. 27, 2023
(86) PCT No.: PCT/EP2023/076747

§ 371 Date: Apr. 28, 2025

(30) Foreign Application Priority Data
Oct. 26, 2022 (FR) FR2211168

(51) Int. Cl. H04N 23/54; H04N 23/55; H04N 23/60; H04N 23/667; H04N 23/69; H04N 23/81

(52) U.S. Cl. CPC H04N 23/54; H04N 23/55; H04N 23/64; H04N 23/667; H04N 23/69; H04N 23/81

(57) ABSTRACT

An in-vehicle image capture device for acquiring at least one image inside the vehicle. The device includes an at least infrared-sensitive camera arranged to acquire the at least one image. The camera includes a main optical axis; a protective panel including a secondary optical axis. The protective panel is arranged to mechanically protect the camera. The camera includes at least one optical element arranged to add, to at least one portion of the at least one image, a barrel optical distortion. The protective panel is arranged to add, to the at least one portion of the at least one image, a pincushion optical distortion.

### TECHNICAL FIELD OF THE INVENTION

The present invention relates in general to an image capture device housed on board a vehicle.

It relates more specifically to an image capture device housed on board a vehicle for acquiring images of the inside of the vehicle with zero or very low distortion, for example distortion of less than or equal to 5%.

### PRIOR ART

Infrared cameras designed to acquire images inside vehicles generally have a wide field of view so as to be able to acquire all or a large portion of the inside of the vehicle. However, the wider the field of view of the camera, the more the optical performance of these cameras may be degraded by the presence of optical aberrations, thereby potentially affecting the quality of the images acquired by such cameras. Among optical aberrations, distortion is an optical aberration that increases when the field of view increases. As a result, the larger the field of view of these cameras, the more distortion increases.

Image capture devices that comprise an infrared-sensitive camera and a protective panel for mechanically protecting the camera, for example from people or objects present inside the vehicle, are known. When it is desired to correct optical aberrations of the camera, at least one additional optical element is generally positioned in front of the camera optics. These devices work but pose various problems, in particular in terms of footprint and implementation, since these devices require the use of at least one additional optical element and costs associated with the addition of additional optical components. Moreover, the addition of optical components also involves losses with regard to the intensities of the light rays captured by the camera, thus degrading optical criteria related to image contrast, such as the modulation transfer function, the point spread function (PSF), etc.

The invention aims to overcome at least one of the abovementioned drawbacks.

### OVERVIEW OF THE INVENTION

In order to overcome the abovementioned drawbacks of the prior art, the present invention proposes an image capture device housed on board a vehicle for acquiring at least one image inside said vehicle, said device comprising:
an at least infrared-sensitive camera designed to acquire said at least one image, said camera comprising a primary optical axis,
a protective panel comprising a secondary optical axis, said protective panel being designed to mechanically protect said camera by at least partially covering the field of view of said camera,
   characterized in that said camera comprises at least one optical element designed to introduce an optical barrel distortion on at least one portion of the at least one image, said protective panel being designed to introduce an optical pincushion distortion on the at least one portion of the at least one image.

In the device according to the present disclosure, no additional optical element is added to compensate for the distortion introduced by the camera. Optical properties have been added to this panel to compensate for the distortion introduced by the camera.

Thus, by virtue of the invention, since no additional optical element is added to compensate for the distortion introduced by the camera, the device of the present disclosure is less bulky, easier to implement and less expensive. Moreover, such a device makes it possible to limit optical losses caused by the presence of additional optical elements. As a result, contrast-related optical performance is improved compared to systems from the prior art.

Distortion is understood to mean an optical aberration introduced by an optical element. This distortion may, as is known, be expressed by Seidel polynomials.

Other advantageous and non-limiting features of the device according to the invention, taken individually or in any technically feasible combination, are explained below.

In one embodiment, the protective panel is at least partially transparent in the infrared; for example, the protective panel has a transparency greater than 85% in the field of view of the camera covered by said protective panel in the infrared.

In one embodiment, said secondary optical axis is angularly offset from the primary optical axis by at least one rotation about an axis transverse to the primary optical axis.

Such an arrangement makes it possible to choose specific portions of the image to compensate for the distortion introduced by the camera in these portions, while providing a device that is inexpensive and easy to implement.

In one embodiment, the secondary optical axis is inclined with respect to the primary optical axis by a first angle.

In one embodiment, the secondary optical axis is inclined with respect to the primary optical axis by a second angle.

In one embodiment, the first angle is between 1 degree and 40 degrees, preferably between 5 and 19 degrees, and/or the second angle is between 1 degree and 40 degrees, preferably between 5 and 19 degrees.

Choosing the inclination of the first and/or second angle allows the portions of the image to be selected precisely.

In one embodiment, the protective panel comprises an outer surface and an inner surface, opposite the outer surface and oriented so as to face said camera:
said outer surface comprising a portion having an outer radius of curvature, and/or
said inner surface comprising a portion having an inner radius of curvature.

In one particular embodiment, the outer and inner radii of curvature are distinct.

In one embodiment, the inner radius of curvature is between 50.0 millimeters and 1990.0 millimeters and/or the outer radius of curvature is between 50.0 millimeters and 1990.0 millimeters.

In another embodiment, the outer and inner radii of curvature are similar to within 10%.

In one embodiment, the camera comprises a total field of view, the inner radius of curvature and/or the outer radius of curvature being curved over the entire total field of view of said camera.

In one embodiment, the portion of the outer surface has a diameter of between 5.0 millimeters and 10.0 centimeters and/or the portion of the inner surface has a diameter of between 5.0 millimeters and 10.0 centimeters.

In one embodiment, the camera is spaced from the protective panel by a distance that varies between 0.5 millimeters and 10.0 centimeters along the primary optical axis.

In another embodiment, the camera is designed to introduce the optical barrel distortion into at least one peripheral region of said image, said protective panel being designed to introduce said optical pincushion distortion into said at least one peripheral region.

In one embodiment, the protective panel is designed to introduce a maximum offset of 120.00 micrometers on the at least one portion of the at least one image compared to a portion of an image that is not distorted by the protective panel, said offset being defined between an object belonging both to the at least one image and to said non-distorted image, said object in the at least one image having a spatial position in the at least one image similar to a spatial position of the object in said non-distorted image.

In one embodiment, the protective panel is designed to reduce the optical barrel distortion introduced by said camera by at least 10%, preferably by at least 50%.

In one embodiment, the optical barrel distortion obtained on said image is less than or equal to 5% over the entire image or over at least one region of the image.

In another embodiment, the camera has a total field of view greater than 30 degrees, preferably between 30.0 and 110.0 degrees.

In one embodiment, the optical element is designed to introduce an optical pincushion distortion on at least one other portion of the at least one image, said protective panel being designed to introduce an optical barrel distortion on the at least one other portion of the at least one image in order to compensate for the pincushion distortion introduced by said camera.

The invention also proposes a display device housed on board a vehicle for acquiring at least one image inside said vehicle, said device comprising:
an at least infrared-sensitive camera designed to acquire said at least one image, said camera comprising a primary optical axis,
a protective panel comprising a secondary optical axis, said protective panel being designed to mechanically protect said camera,
   characterized in that said camera comprises at least one optical element designed to introduce an optical distortion on at least one portion of the at least one image, said protective panel being designed to introduce, on the at least one portion of the at least one image, an optical distortion with a sign opposite said optical distortion introduced by the camera, said secondary optical axis being angularly offset from the primary optical axis by at least one rotation about an axis transverse to the primary optical axis.

The other embodiments listed above are also applicable to this embodiment.

In one embodiment, the optical distortion introduced by the optical element of the camera is a barrel distortion, while the optical distortion with an opposite sign introduced by the protective panel is a pincushion distortion.

Of course, in another embodiment, the optical distortion introduced by the optical element of the camera is a pincushion distortion, while the optical distortion with an opposite sign introduced by the protective panel is a barrel distortion.

Of course, the various features, variants and embodiments of the invention may be associated with one another in various combinations provided that they are not mutually exclusive or incompatible.

### DETAILED DESCRIPTION OF THE INVENTION

The description that follows with reference to the appended drawings, which are given by way of non-limiting examples, will give a good understanding of the content of the invention and how it may be implemented.

In the appended drawings:

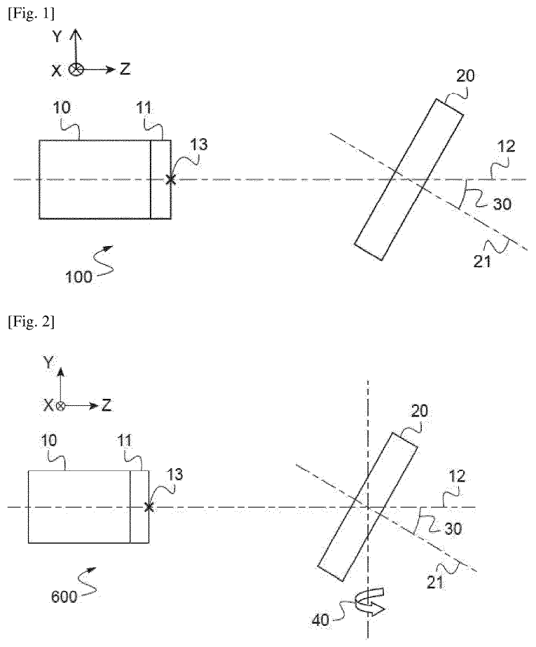

FIG. 1 is a schematic depiction of one embodiment of a device according to the present invention, in a viewing plane seen from above;

FIG. 2 is a schematic depiction of another embodiment of a device according to the present invention, in a viewing plane seen from above;

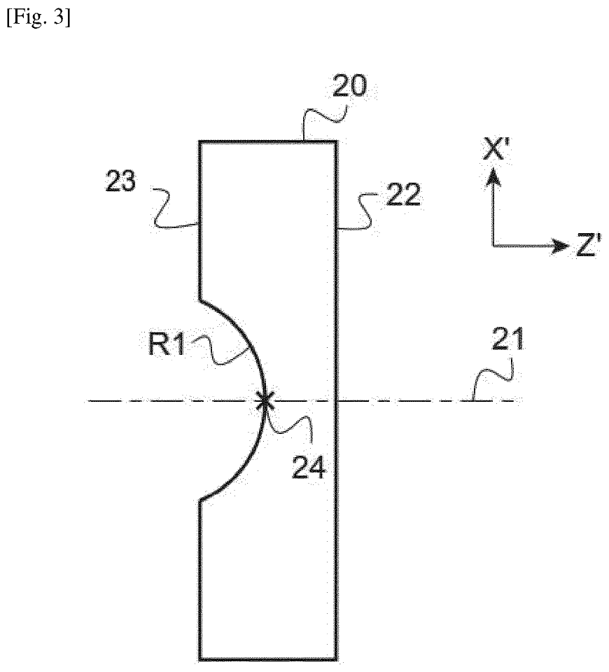

FIG. 3 is a schematic depiction of one embodiment of a protective panel used in the device according to the present disclosure, in a viewing plane of the protective panel;

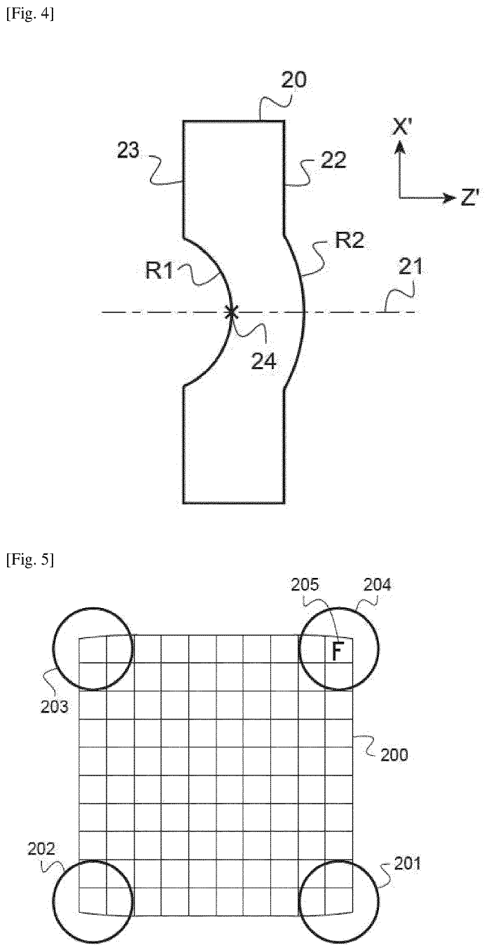

FIG. 4 is a schematic depiction of a second embodiment of a protective panel used in the device according to the present disclosure, in a viewing plane of the protective panel;

FIG. 5 is a schematic depiction of one example of an image acquired by a camera without the protective panel of the device according to the present disclosure and without any additional optical element to compensate for the distortion introduced by the camera;

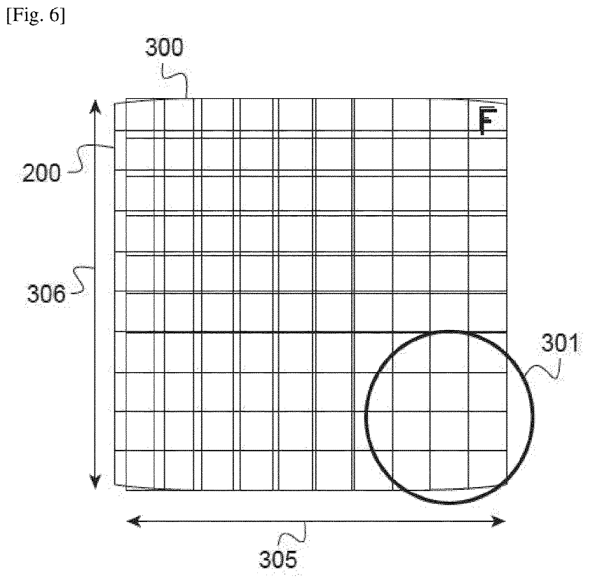

FIG. 6 is a schematic depiction of the example of the image acquired in FIG. 5 by a camera illustrated in FIG. 1, and of one example of an image acquired by the device according to the present disclosure;

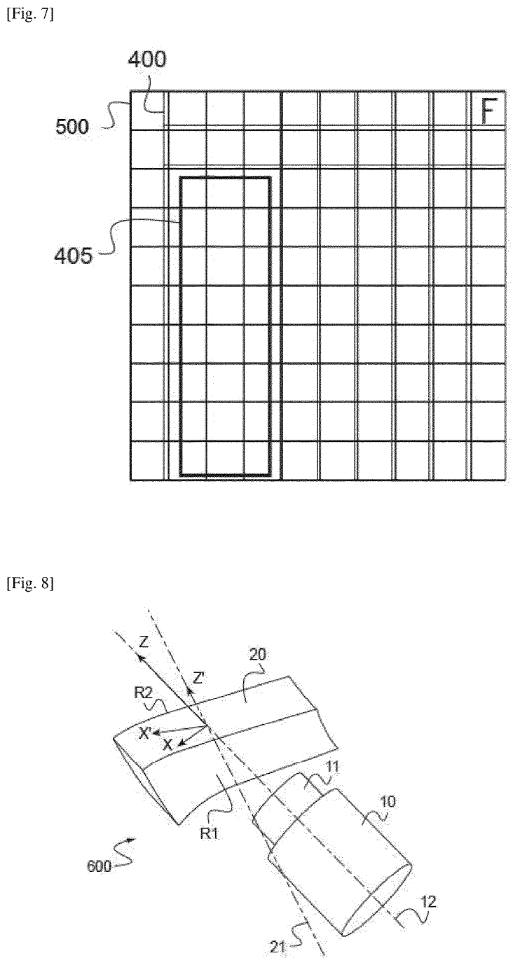

FIG. 7 is a schematic depiction of an image of a target without distortion, and of one example of an image acquired by the device according to the present disclosure;

FIG. 8 is a schematic depiction of the embodiment of the device illustrated in FIG. 2 in another viewing plane.

### DEVICE

One exemplary embodiment of an image capture device 100 housed on board a vehicle according to the present disclosure will be described with reference to FIG. 1, FIG. 3 and FIG. 4.

The device 100 illustrated in FIG. 1 comprises a camera 10 and a protective panel 20. The camera 10 comprises at least one optical element 11. The optical element 11 is, by way of example, a lens associated with the camera, such as a lens of the objective associated with the camera 10.

An optical element is understood to mean an element that has at least one of the following optical characteristics, such as an aperture, a focal length, a field, a diameter and a radius of curvature.

The camera 10 of the device 100 is an infrared-sensitive camera. For example, the camera is sensitive to near-infrared wavelengths, for example between 780 nanometers and 1400 nanometers. Of course, the camera 10 may also be sensitive to wavelengths in the visible spectrum of for example between 400 nanometers and 780 nanometers (780 nanometers preferably excluded).

In the device 100, the camera 10 is designed to acquire at least one image, in particular an image inside the vehicle.

In the example illustrated in FIG. 1, the camera 10 has a primary optical axis 12. The primary optical axis 12 is arranged so as to pass through an optical center of the optical element 11. The primary optical axis 12 is also coincident with an optical axis of the optical element 11.

The protective panel 20 illustrated in FIG. 1 is designed to mechanically protect the camera 10 by partially covering a field of view of the camera 10, in particular from mechanical impacts. According to the present disclosure, the protective panel 20 is designed to protect the camera from at least 10 mechanical impacts per spatial direction (x, y, z) equal to an acceleration of 500 m/s² or less than an acceleration of 500 m/s².

A protective panel is understood to mean an element that has at least one of the following mechanical characteristics, such as a hardness level, a thickness designed to give it a rigidity level and/or a level of protection against moderate impacts. By way of example, the Shore D hardness level is less than 40. A moderate impact is understood to mean impacts of less than 500 m/s².

In this example, the protective panel 20 is made of polycarbonate and has a transparency greater than 85% at least in the infrared, for example for wavelengths between 700 nanometers and 1400 nanometers, preferably between 780 nanometers and 1400 nanometers. In the example under consideration, the protective panel 20 has a transparency of 89%.

In the example of the device 100, the optical element 11 of the camera is designed to introduce a distortion on at least one portion of the image and the protective panel 20 is designed to introduce a distortion on the at least one portion of the image with a sign opposite the distortion introduced by the optical element 11 of the camera 20. Thus, by virtue of the device 100, the distortion introduced by the camera 10 is compensated for by the distortion introduced by the protective panel, while preserving the mechanical properties of the protective panel. Such a device thus makes it possible, locally, easily and inexpensively, to cancel out the distortion that would have occurred on the image without a protective panel according to the present disclosure. Furthermore, in the device 100, it is not necessary to add, in addition to the camera 10, any other optical element in order to compensate for the distortion introduced by the camera 10, thereby improving the footprint of the device 100, promoting easier integration of the camera into the inside of the vehicle and also making the price thereof more favorable.

By way of example, the distortion introduced by the optical element 11 into the at least one portion of the image is barrel distortion, while the distortion introduced by the protective panel 20 is pincushion distortion. Barrel distortion is understood to mean a negative distortion, and pincushion distortion is understood to mean a positive distortion. This distortion may be translated by 3rd-order Seidel polynomials. In another example, this distortion may be decomposed into a 3rd-order and 5th-order aberration in Seidel polynomials.

The protective panel 20 illustrated in FIG. 1 comprises a secondary optical axis 21. A primary optical axis 12 or secondary optical axis 21 is understood to mean the optical axis of a centered system that corresponds to the axis of rotational symmetry of this system.

In the example illustrated in FIG. 1, the secondary optical axis 21 of the protective panel 20 is angularly offset from the primary optical axis 12 by at least one rotation about an axis, for example an axis transverse to the primary optical axis (axis x) 12 and/or another axis transverse to the optical axis (axis y).

The angular offset is related to the positions of the distortion that it is desired to compensate for in the image. The greater the offset (for example when it is greater than 19 degrees), the more the device 100 is designed to compensate for distortion toward the edges or peripheral regions of the image (i.e. and less in the central region of the image). Conversely, a small offset, for example less than 10 degrees, makes it possible to compensate more for distortion toward the center of the image.

In the first viewing plane illustrated by FIG. 1 (view from above), the secondary optical axis 21 is angularly offset from the primary optical axis 12 by a rotation about an axis transverse to the primary optical axis 12, oriented here along the axis x of the camera reference frame. The secondary optical axis is therefore inclined with respect to the primary optical axis 12 by a first angle 30. By way of example, the first angle 30 is between 0.001 degrees and 40 degrees, preferably between 5 and 19 degrees.

Optionally and in the device 100, the protective panel 20 of the device 100 comprises an inner surface 23 and an outer surface 22, as explained below in the example of FIG. 3 and FIG. 4. In addition, the camera 10 is spaced from the protective panel 20 by a distance d that varies between 1.00 millimeter and 10.00 centimeters along the primary optical axis 12. This point will also be detailed below following FIG. 3 and FIG. 4.

A second example of a device 600 will be described with reference to FIG. 2, FIG. 3, FIG. 4 and FIG. 8. The device 600 comprises all of the elements of the device 100 illustrated in FIG. 1. Only the differences in relation to FIG. 1 will thus be described.

The device 600 illustrated in FIG. 2 and in FIG. 8 comprises the camera 10 and the protective panel 20. The camera 10 comprises at least the optical element 11. The protective panel 20 illustrated in FIG. 2 and FIG. 8 comprises a secondary optical axis 21. In this example, the secondary optical axis is angularly offset from the primary optical axis 12 by a rotation about the axis transverse to the primary optical axis 12, oriented here along the axis x of the camera 10 reference frame. Typically, the secondary optical axis 21 is inclined with respect to the primary optical axis 12 by the first angle 30, which is 7 degrees here.

In the exemplary embodiment illustrated in FIG. 2 and in FIG. 8 (schematic illustrations), the secondary optical axis 21 is also angularly offset from the primary optical axis 12 by a rotation along an axis transverse to the primary optical axis 12, here the axis y. Thus, in this example, the rotation is decomposed into two rotations using the Euler angles R=R^{x}_{α}R^{y}_{β}, where R^{x}_{α} is a rotation about the initial transverse axis x of the camera 10 of angle α, with α as the first angle 30, and R^{y}_{β} is a rotation about the initial axis y of the camera 10 of angle β, with β as the second angle 40. The protective panel 20 is therefore also inclined with respect to the camera 10 by a second angle 40 with respect to the transverse axis y of the camera, defining a second axis z′ for the protective panel 20.

By way of example, the second angle 40 is between 0.001 degrees and 40 degrees, preferably between 5 and 19 degrees. Such an offset makes it possible to compensate for the distortion introduced by the camera 10 in various regions of the image, for example on peripheral regions of the image (or the edges of the image) and on regions close to the center of the image.

In the example illustrated in FIG. 2 and FIG. 8, the first angle 30 is equal to 7 degrees and the second angle is equal to 17 degrees.

A description will now be given, with reference to FIG. 3 and FIG. 4, of some examples of the design of the protective panel 20 used in the devices 100 and 600. In the examples illustrated in FIG. 1 and in FIG. 2, the protective panel 20 comprises an inner surface 23 and an outer surface 22, as illustrated in FIG. 3. The inner surface 23 is oriented so as to face the camera 10, in particular the optical element 11. However, in practice, the protective panel 20 is produced as described in FIG. 3 and in FIG. 4.

In FIG. 3, the inner surface 23 comprises a portion having an inner radius of curvature R1, which is concave in shape in FIG. 1 and FIG. 2 (given in the direction defined from the camera 10 toward the protective panel 20). The other portions of the inner surface 23 are preferably plane. Thus, according to this example, the secondary optical axis 21 is the optical axis that passes through the center of the inner surface 23 comprising the radius of curvature R1 and that is perpendicular to a plane of the inner surface 23 comprising said radius of curvature R1.

By way of example, the inner radius of curvature R1 is between 50.00 millimeters and 1990.00 millimeters. In the example illustrated, the inner radius of curvature R1 is 55.16 millimeters.

The curved portion of the inner surface 23 has a diameter of between 5.00 millimeters and 10 centimeters. In the example illustrated, the diameter of the radius of curvature R1 is 10 millimeters.

In addition, in the example of FIG. 1 and FIG. 2, the camera 10 is spaced from the protective panel 20 by a distance d that varies between 1.00 millimeter and 10.00 centimeters along the primary optical axis 12. In this embodiment, the distance d is defined between the optical center 13 of the optical element 11 and the optical center 24 of the portion having the radius of curvature R1.

Without limitation, the camera 10 comprises a total field of view, for example of 60 degrees. According to one example, the inner radius of curvature R1 is curved over the entire total field of view of said camera 10. Such an arrangement makes it possible to correct distortion on all portions of the image. The diameter of the curved portion (inner radius R1) of the inner surface 23 is therefore adapted to the total field of view of the camera 10. It is therefore chosen depending on the total field of view of the camera, so as to cover it entirely.

FIG. 4 also illustrates another exemplary embodiment of a protective panel 20. The protective panel 20 in this example has an inner surface 23 with a radius of curvature R1 explained as above in FIG. 3. In addition, the outer surface 22 of the protective panel 20 comprises a portion having an outer radius of curvature R2. Outer is understood to mean a surface positioned on the side of an object seen by the camera. The outer radius of curvature R2 is designed to introduce an additional distortion identical to the distortion introduced by the radius of curvature R1 of the inner surface 23. Such an arrangement makes it possible to improve correction of the distortion introduced in the camera 10. In FIG. 4, the outer radius of curvature R2 is positioned facing the inner radius of curvature R1. The optical center of the inner radius of curvature R1 and the optical center of the outer radius of curvature R2 are thus aligned with the secondary optical axis 21 of the protective panel 20.

Preferably, in this embodiment, the inner radius of curvature R1 is concave in shape and the outer radius of curvature R2 has a convex shape. Of course, in another embodiment, the outer radius of curvature R2 may be concave in shape.

In this exemplary embodiment illustrated in FIG. 4, the inner radius of curvature R1 and outer radius of curvature R2 are similar to within 10% in terms of absolute value. Preferably, the radius of curvature R2 of the outer surface 22 differs from the radius of curvature R1 of the inner surface 23 by ±10 percent in terms of absolute value. Such a characteristic makes it possible to preserve the optical quality of the device 100, 600. Typically, no drop in the modulation transfer function (MTF) is observed with such an arrangement of the device 100, 600 following the addition of the curvature R2 of the outer surface 22. By way of example, the inner surface 23 has a radius of curvature R1 of 55.17 millimeters and 10.00 millimeters in diameter, while the outer surface 22 has a radius of curvature R2 of 55.00 millimeters and 10.00 millimeters in diameter.

In this example, the difference between the radius of curvature R1 and the radius of curvature R2 is therefore less than 0.1%. This arrangement thus makes it possible to improve the optical qualities of the device 100, 600 and therefore to obtain an image of better quality (that is to say less distorted than an image obtained with a protective panel that does not introduce distortion and/or compared to an image obtained with the embodiment illustrated in FIG. 3). In this embodiment, the inner radius R1 and the outer radius R2 are thus optimized (that is to say selected) so as to improve the overall performance of the device 100, 600.

In another example of this embodiment, the outer surface 22 may be imposed by the manufacturer (style constraints in the vehicle). In this case, the inner radius of curvature R1 of the inner surface 23 is optimized so as to maximize an optical function of the device 100, 600. The optimization thereof may depend on the outer radius of curvature R2 of the outer surface 22, on the inclination of the protective panel 20, and on an optical index of the protective panel 20, which, in this example, is the optical index of polycarbonate. FIG. 8 illustrates such an example. In this example, the inner and outer radii of curvature R1 and R2 have a similar optical design, that is to say designs that differ by at most ±10 percent in terms of absolute value, preferably less than ±1 percent.

Thus, in the two examples illustrated by FIG. 4 and FIG. 8, the inner radius of curvature R1 is optimized with respect to the outer surface 22, and therefore depends on the outer radius of curvature R2. Optimizing the inner radius of curvature R1 of the inner surface 23 with respect to the outer surface 22 will make it possible to maximize the overall optical function of the device 100 and 600. An overall optical function is understood to mean a function that makes it possible to assess the optical quality of the device 100 and 600. By way of example, the optical function may be based on the optical transfer function, known as MTF, or on the point spread function, known as PSF. Such an arrangement makes it possible to obtain a device with an optical function of better quality.

FIG. 5 illustrates one example of an image 200 acquired by a camera 10 having an optical barrel aberration. For this image 200, a test pattern is imaged by the camera 10. The test pattern contains at least one letter 205 and a perfect grid with straight lines. The acquired image 200 illustrated in FIG. 5 is not corrected by the distortion introduced by the protective panel 20.

In this example, the camera that is used has a total field of view of 44 degrees×36 degrees. This camera uses an optical element having a barrel distortion equal to or less than 4 pixels, preferably of the order of 3-4 pixels of offset in the edges of the total field of view of the camera. The camera 10 has a sensor with pixels of a size of 3 micrometers. The acquired image 200 in this example thus has peripheral portions 201, 202, 203, 204 close to the corners of the image 200. The peripheral portions 201, 202, 203, 204 exhibit barrel distortion. The peripheral portions 201, 202, 203, 204 each correspond to a square of four pixels positioned at a corner of the image 200.

FIG. 6 compares the acquired image in FIG. 5 with an image 300 acquired by the device 100 or 600, for example the one shown in FIG. 1, FIG. 2, FIG. 3 or FIG. 4. The camera 10 of the device 100 or 600 is identical to the camera used in the example of FIG. 5. The images 200 and 300 are thus of the same size. The camera 10 that is used has imaged one and the same object, here a test pattern depicting a grid and a letter (letter F).

In this example, the protective panel 20 comprises a radius of curvature R1 on its inner surface 23 of 55.17 millimeters and a diameter of the order of 10.00 millimeters. The protective panel 20 comprises a radius of curvature R2 on its outer surface 22 of 55.00 millimeters and a diameter of the order of 10.00 millimeters. In addition, the outer surface 22 of the protective panel 20 is placed 6.2 millimeters away from the surface of the optical element 11 of the camera 10 positioned facing the inner surface 23 of the protective panel 20. The protective panel 20 has a thickness of 2.3 millimeters oriented along the primary optical axis 12. In this example, the secondary optical axis 21 is angularly offset from the primary optical axis 12 by a rotation about the initial transverse axis x of the camera 10 by the first angle 30 equal to 7.0 degrees and by a rotation about the initial transverse axis y of the camera 10 by the second angle 40 equal to 19.0 degrees.

Similarly, for the image 300, the same test pattern is imaged by the device 100 or 600. In this example, the image 300 has a peripheral portion 301. At the peripheral portion 301, the image 300 is superimposed on the image 200 (at the peripheral portion 201 of the image 200). The peripheral portion 301 of the image 300 has a spatial position in the image 300 that is identical to the spatial position of the peripheral portion 201 of the image 200. In this example, the spatial position is defined using the pixels of the image in question, in particular depending on the position of the pixels in the image in question. The protective panel 20 thus does not introduce any additional distortion into the peripheral portion 301 of the image 300. The peripheral portion 301 of the image 300 exhibits a distortion that is, by way of example, smaller than the size of a pixel, that is to say of the order of one micrometer (less than around ten micrometers). For the other portions of the image 200 and 300, an offset between the image 200 and 300 is observed along a first spatial direction 305 and a second spatial direction 306 of the images 200, 300. In this example, the protective panel 20 is designed to introduce at most an offset of 120 micrometers (with a sign opposite the offset introduced by the camera 10) in order to compensate for the distortion introduced by the camera 10. This offset may be different depending on the spatial directions of the image 300. By way of example, the offset between the image 200 and the image 300 in the first spatial direction is preferably less than 120.0 micrometers, and the offset of the image 200 and the image 300 in the second spatial direction is preferably less than 50.0 micrometers. Thus, in this example, the protective panel 20 introduces a distortion with an opposite sign, here a pincushion distortion, making it possible to locally cancel out the distortion introduced by the camera 10. The barrel distortion introduced by the camera 10 is compensated for in particular at the peripheral edges of the image 300, in this case squares of four pixels positioned in three corners of the image 300 that have a spatial position similar or corresponding to the spatial position of the peripheral portions 202, 203, 204 of the image 200. In this example, the protective panel 20 has reduced the optical barrel distortion introduced by said camera 10 by at least 10% in the regions having a spatial position similar to the spatial position of the peripheral portions 202, 203, 204 of the image 200. Typically, the optical barrel distortion obtained on said image 300 is less than or equal to 5% on at least the regions of the image 300 (here the three edges of the image 300) having a position identified at the peripheral portions 202, 203, 204 of the image 200.

FIG. 7 compares another image 400 obtained with the device 100 or 600 and an image 500 of a test pattern that would be obtained if the camera 10 were not to introduce any distortion, in this case barrel distortion, on the image. The images 400 and 500 are of the same size. In this example, the protective panel 20 comprises a radius of curvature R1 on its inner surface 23 of 55.17 millimeters and a diameter of 10 millimeters. The protective panel 20 comprises a radius of curvature R2 on its outer surface 22 of 55.00 millimeters and a diameter of 10 millimeters. The same test pattern is used to acquire the images 400 and 500. This test pattern contains a grid and a letter (letter F). In this example, the image 400 has a portion 405, here of a size of approximately 3×8 pixels. In this portion 405, the imaged test pattern of the image 400 is superimposed on the test pattern of the image 500. The portion 405 of the image 400 thus does not exhibit any distortion. The letters in each image 400 and 500 are superimposed. In this example, the optical barrel distortion obtained on said image 400 is less than or equal to 5% over the entire image 400.

### VARIANTS

The present invention is in no way limited to the embodiments described and shown, and a person skilled in the art will know how to add any variant thereto in accordance with the invention.

1. An image capture device housed on board a vehicle for acquiring at least one image inside said vehicle, said device comprising:
an at least infrared-sensitive camera configured to acquire said at least one image, said camera comprising a primary optical axis; and
a protective panel comprising a secondary optical axis, said protective panel is configured to mechanically protect said camera by at least partially covering a field of view of said camera,
wherein said camera comprises at least one optical element configured to introduce an optical barrel distortion on at least one portion of the at least one image,
wherein said protective panel is configured to introduce an optical pincushion distortion on the at least one portion of the at least one image.

2. The image capture device as claimed in claim 1, wherein the secondary optical axis is angularly offset from the primary optical axis by at least one rotation about an axis transverse to the primary optical axis.

3. The image capture device as claimed in claim 1, wherein the secondary optical axis is inclined with respect to the primary optical axis by a first angle.

4. The image capture device as claimed in claim 1, wherein the secondary optical axis is inclined with respect to the primary optical axis by a second angle.

5. The image capture device as claimed in claim 1, wherein a first angle is between 1 degree and 40 degrees and/or a second angle is between 1 degree and 40 degrees.

6. The image capture device as claimed in claim 1, wherein the protective panel comprises an outer surface and an inner surface, opposite the outer surface and oriented so as to face said camera,
wherein said outer surface comprising a portion having an outer radius of curvature, or
wherein said inner surface comprising a portion having an inner radius of curvature.

7. The image capture device as claimed in claim 6, wherein the inner radius of curvature is between 50.00 millimeters and 1990.00 millimeters and/or the outer radius of curvature is between 50.00 millimeters and 1990.00 millimeters.

8. The image capture device as claimed in claim 7, wherein the outer radius and the inner radius of curvature are similar to within 10%.

9. The image capture device as claimed in claim 6,
wherein the camera comprises a total field of view,
wherein the inner radius of curvature and/or the outer radius of curvature is curved over an entire total field of view of said camera.

10. The image capture device as claimed in claim 6, wherein the portion of the outer surface has a diameter of between 5.0 millimeters and 10.0 centimeters and/or the portion of the inner surface has a diameter of between 5.0 millimeters and 10.0 centimeters.

11. The image capture device as claimed in claim 1, wherein the camera is spaced from the protective panel by a distance that varies between 1.0 millimeter and 10.0 centimeters along the primary optical axis.

12. The image capture device as claimed in claim 1,
wherein the camera is configured to introduce the optical barrel distortion into at least one peripheral region of said image,
wherein said protective panel is configured to introduce said optical pincushion distortion into said at least one peripheral region.

13. The image capture device as claimed in claim 1,
wherein the protective panel is configured to introduce a maximum offset of 120.00 micrometers on the at least one portion of the at least one image compared to a portion of an image that is not distorted by the protective panel,
wherein said offset is defined between an object belonging both to the at least one image and to said non-distorted image,
wherein said object in the at least one image having a spatial position in the at least one image similar to a spatial position of the object in said non-distorted image.

14. The image capture device as claimed in claim 1, wherein the protective panel is configured to reduce the optical barrel distortion introduced by said camera by at least 10%.

15. The image capture device as claimed in claim 1, wherein the optical barrel distortion obtained on said image is less than or equal to 5% over the entire image or over at least one region of the image.

16. The image capture device as claimed in claim 1, wherein the camera has a total field of view greater than 30 degrees.
